(19) United States
(12) Patent Application Publication
(10) Pub. No.: US 2004/0128488 A1
(43) Pub. Date: Jul. 1, 2004

(54) Strand switching algorithm to avoid strand starvation

(76) Inventors: Chandra M. R. Thimmannagari, Fremont, CA (US); Rabin A. Sugumar, Sunnyvale, CA (US); Sorin Iacobovici, San Jose, CA (US); Robert Nuckolls, Santa Clara, CA (US)

Correspondence Address: OSHA & MAY L.L.P./SUN, 1221 MCKINNEY, SUITE 2800, HOUSTON, TX, 77010, US

(21) Appl. No.: 10/329,855

(22) Filed: Dec. 26, 2002

(51) Int. Cl. G06F 9/00

(52) U.S. Cl. 712/235

(57) ABSTRACT

A method and apparatus for avoiding strand starvation is provided. The method and apparatus selectively switches from a first strand to a second strand dependent on a state of a computer system. The selectively switching is dependent on whether the second strand is alive and whether a value of a counter has reached a particular count.

### BACKGROUND OF INVENTION

As shown in FIG. 1, a computer (24) includes a processor (26), memory (28), a storage device (30), and numerous other elements and functionalities found in computers. The computer (24) may also include input means, such as a keyboard (32) and a mouse (34), and output means, such as a monitor (36). Those skilled in the art will appreciate that these input and output means may take other forms in an accessible environment.

The processor (26) may be required to process multiple processes. The processor (26) may operate in a batch mode such that one process is completed before the next process is run. Some processes may incur long latencies, and thus, in batch mode, no useful work is performed by the processor (26) during these latencies. A processor (26) that is arranged to process two or more processes, or strands, may be able to switch to another strand when a long latency event occurs.

The processor (26) may include several register files and maintain several program counters. Each register file and program counter holds a program state for a separate strand. When a long latency event occurs, such as a cache miss, the processor (26) switches to another strand. The processor (26) executes instructions from another strand while the cache miss is being handled.

In some instances, a single strand may not incur any long latencies. If a single strand is continuously processed, another strand may “starve.” In other words, one strand consumes a vast majority of the processing cycles of the processor (26) at the expense of one or more other strands.

### SUMMARY OF INVENTION

According to one aspect of the present invention, a method for processing instructions comprising fetching a first strand where the first strand comprises instructions from a first process; fetching a second strand where the second strand comprises instructions from a second process; and selectively switching from the first strand to the second strand dependent on whether a value of a counter has reached a particular count.

According to one aspect of the present invention, an apparatus comprising a commit unit arranged to identify instructions that have been committed for execution; a counter arranged to count; an instruction decode unit arranged to decode instructions from a first strand and a second strand where the instruction decode unit selectively switches from the first strand to the second strand; and a strand selection circuit arranged to indicate when to selectively switch from the first strand to the second strand dependent on whether the commit unit indicates that the second strand is alive, and whether the counter has reached a particular value.

According to one aspect of the present invention, a computer system comprising a processor arranged to process a first strand and a second strand; an instruction decode unit arranged to decode instructions for the processor where the instruction decode unit is arranged to selectively switch from the first strand to the second strand; and instructions adapted to cause the computer system to selectively switch from the first strand to the second strand dependent on whether the second strand is alive, and whether a value of a counter has reached a particular count.

According to one aspect of the present invention, an apparatus comprising means for fetching a first strand where the first strand comprises instructions from a first process; means for fetching a second strand where the second strand comprises instructions from a second process; means for determining whether the second strand is alive; means for determining whether a value of a counter has reached a particular count; and means for selectively switching from the first strand to the second strand dependent on the means for determining whether the second strand is alive and the means for determining whether the value of the counter has reached the particular count.

Other aspects and advantages of the invention will be apparent from the following description and the appended claims.

### BRIEF DESCRIPTION OF DRAWINGS

FIG. 1 shows a block diagram of a prior art computer system.

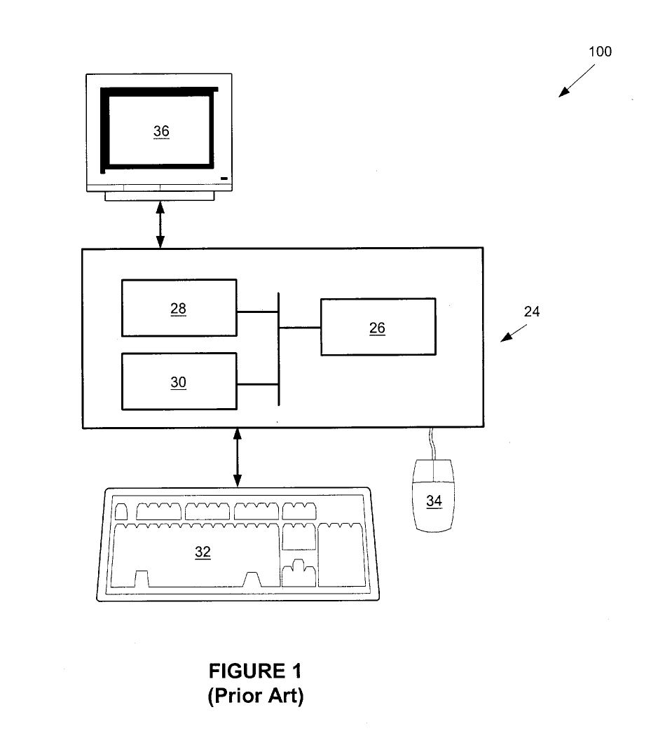

FIG. 2 shows a block diagram of a computer system pipeline in accordance with an embodiment of the present invention.

FIG. 3 shows a flow diagram of a strand starvation avoidance algorithm in accordance with an embodiment of the present invention.

FIG. 4 shows a dual strand pipeline diagram in accordance with an embodiment of the present invention.

FIG. 5 shows a dual strand pipeline diagram in accordance with an embodiment of the present invention.

### DETAILED DESCRIPTION

Embodiments of the present invention relate to an apparatus and method for avoiding strand starvation. The method and apparatus selectively switches from a first strand to a second strand dependent on a state of a computer system. The selective switching may be dependent on an existence of a second strand, an availability of resources to handle the processing of either the first or second strand, and/or a counter.

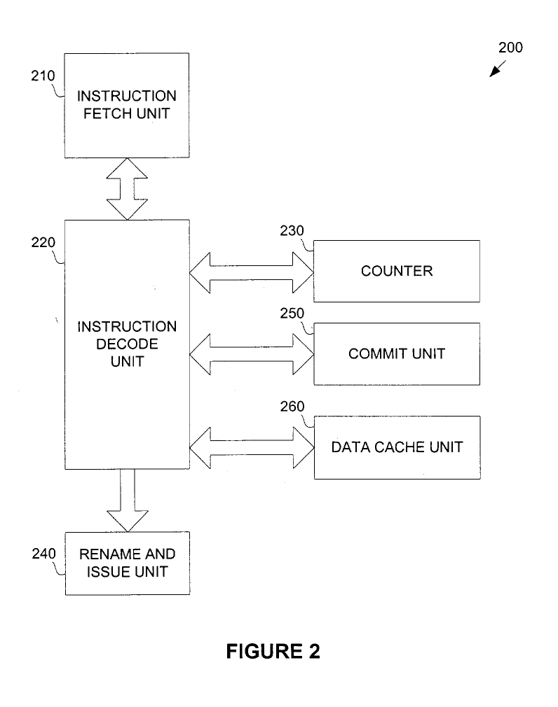

FIG. 2 shows a block diagram of an exemplary computer system pipeline (200) in accordance with an embodiment of the present invention. The computer system pipeline (200) includes an instruction fetch unit (210), an instruction decode unit (220), a counter (230), a rename and issue unit (240), a commit unit (250) and a data cache unit (260). Those skilled in the art will note that not all functional units of a computer system pipeline are shown in the computer system pipeline (200), e.g., an execution unit. Any of the units (210, 220, 230, 240, 250, 260) may be pipelined or include more than one stage. Accordingly, any of the units (210, 220, 230, 240, 250, 260) may take longer than one cycle to complete a process.

The instruction fetch unit (210) is responsible for fetching instructions from memory. Accordingly, instructions may not be readily available, i.e., a miss occurs. The instruction fetch unit (210) performs actions to fetch the proper instructions.

The instruction fetch unit (210) allows two instruction strands to be running in the instruction fetch unit (210) at any time. Only one strand, however, may actually be fetching instructions at any time. At least two buffers are maintained to support the two strands. The instruction fetch unit (210) fetches bundles of instructions. For example, in one or more embodiments, up to three instructions may be included in each bundle.

In one embodiment, the instruction decode unit (220) is divided into two decode stages (D1, D2). D1 and D2 are each responsible for partial decoding of an instruction. D1 may also flatten register fields, manage resources, kill delay slots, determine strand switching, and determine the existence of a front end stall. Flattening a register field maps a smaller number of register bits to a larger number of register bits that maintain the identity of the smaller number of register bits and additional information such as a particular architectural register file. A front end stall may occur if an instruction is complex, requires serialization, is a window management instruction, results in a hardware spill/fill, has an evil twin condition, or a control transfer instruction, i.e., has a branch in a delay slot of another branch.

A complex instruction is an instruction not directly supported by hardware and may require the complex instruction to be broken into a plurality of instructions supported by hardware. An evil twin condition may occur when executing a fetch group that contains both single and double precision floating point instructions. A register may function as both a source register of the single precision floating point instruction and as a destination register of a double precision floating point instruction, or vice versa. The dual use of the register may result in an improper execution of a subsequent floating point instruction if a preceding floating point instruction has not fully executed, i.e., committed the results of the computation to an architectural register file.

The counter (230) is responsible for tracking a number of clock cycles or a number of time intervals. The counter (230) may be integrated into the instruction decode unit (220). The counter (230) may indicate when a strand switch is desirable.

The rename and issue unit (240) is responsible for renaming, picking, and issuing instructions. Renaming takes flattened instruction source registers provided by the instruction decode unit (220) and renames the flattened instruction source registers to working registers. Renaming may start in the instruction decode unit (220). Also, the renaming determines whether the flattened instruction source registers should be read from an architectural or working register file.

Picking monitors an operand ready status of an instruction in an issue queue, performs arbitration among instructions that are ready, and selects which instructions are issued to execution units. The rename and issue unit (240) may issue one or more instructions dependent on a number of execution units and an availability of an execution unit. The computer system pipeline (200) may be arranged to simultaneously process multiple instructions.

Issuing instructions steers instructions selected by the picking to an appropriate execution unit.

The commit unit (250) is responsible for maintaining an architectural state of both strands and initiating traps as needed. The commit unit (250) keeps track of which strand is “alive.” A strand is alive if a computer system pipeline has instructions for the strand, and the strand is not in a parked or wait state. A parked state or a wait state is a temporary stall of a strand. A parked state is initiated by an operating system, whereas a wait state is initiated by program code. When a change in the number of strands that are alive occurs, the commit unit (250) restarts the strands in the new state.

The data cache unit (260) is responsible for providing memory access to load and store instructions. Accordingly, the data cache unit (260) includes a data cache, and surrounding arrays, queues, and pipes needed to provide memory access.

In FIG. 2, each of the units (210, 220, 230, 240, 250, 260) provides processes to load, break down, and execute instructions. Resources are required to perform the processes. In an embodiment of the present invention, resources are any queue that may be required to process an instruction. For example, the queues include a live instruction table, issue queue, integer working register file, floating point working register file, condition code working register file, load queue, store queue, and branch queue. As some resources may not be available at all times, some instructions may be stalled. Furthermore, because some instructions may take more cycles to complete than other instructions, or resources may not currently be available to process one or more of the instructions, other instructions may be stalled. A lack of resources may cause a resource stall. Instruction dependency may also cause some stalls. Accordingly, switching strands may allow some instructions to be processed by the units (210, 220, 230, 240, 250, 260) that may not otherwise have been processed at that time.

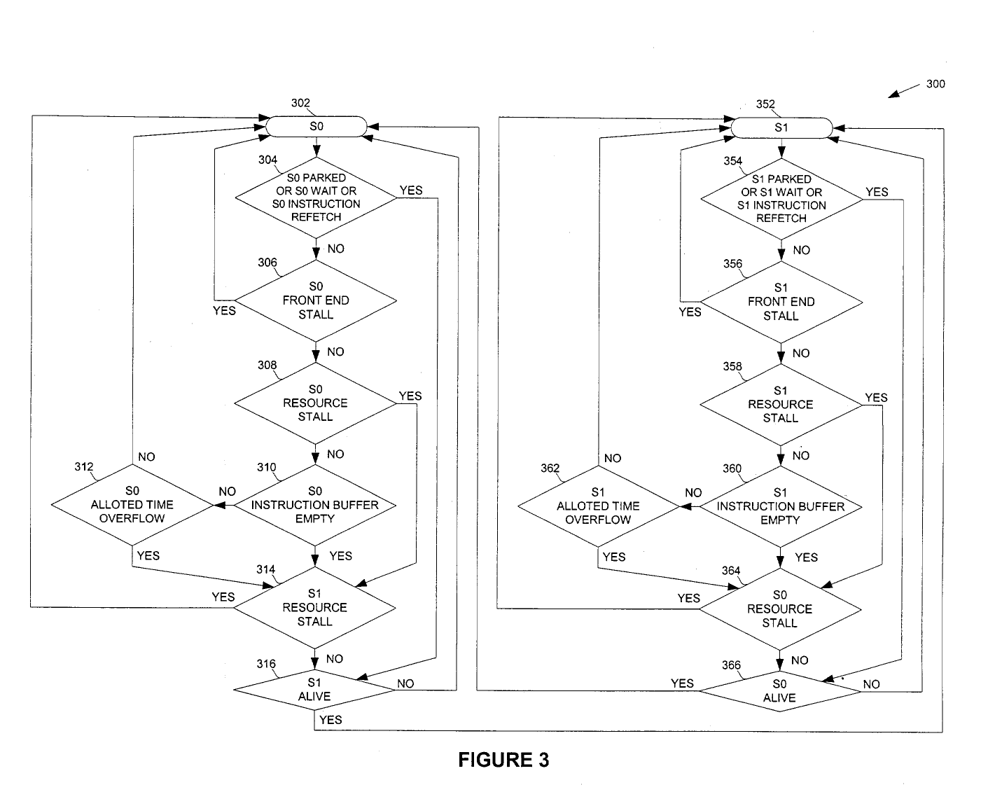

FIG. 3 shows a flow diagram of an exemplary strand starvation avoidance algorithm (300) in accordance with an embodiment of the present invention. In the diagram shown, two strands are used for the exemplary strand starvation avoidance algorithm (300). Those skilled in the art will appreciate that a larger number of strands may also be used.

In this embodiment, during power-on one of the strands is allowed to proceed until a decision is made to switch to the other strand. For example, if strand 0 (S0) is allowed to proceed, then an instruction(s) from strand 0 (S0) enters D1 (302). In some embodiments, the instruction(s) may be part of a bundle of instructions. A determination is made as to whether strand 0 (S0) is in a parked state or a wait state, or has caused an instruction refetch (304). An instruction refetch, also referred to as a refetch, may occur if a branch misprediction or trap occurs. If strand 0 (S0) is not in a parked state or a wait state, or has not caused an instruction refetch, a determination is made as to whether a front end stall for strand 0 (S0) has occurred (306). If strand 0 (S0) is in a parked or a wait state, or has caused an instruction refetch, a determination is made as to whether strand 1 (S1) is alive (316).

If a front end stall for strand 0 (S0) has not occurred, a determination is made as to whether a resource stall for strand 0 (S0) has occurred (308). If a front end stall for strand 0 (S0) has occurred, strand 0 (S0) is continued (302). If strand 0 (S0) does not have a resource stall, a determination is made as to whether an instruction buffer for strand 0 (S0) is empty (310). If strand 0 (S0) does have a resource stall, a determination is made as to whether a resource stall for strand 1 (S1) has occurred (314).

If an instruction buffer for strand 0 (S0) is not empty, a determination is made as to whether a value of a counter (e.g., counter (230) shown in FIG. 2) has reached a particular count (312). If an instruction buffer for strand 0 (S0) is empty, a determination is made as to whether a resource stall for strand 1 (S1) has occurred (314). If a value of a counter has not reached a particular count, strand 0 (S0) is continued (302). If a value of a counter has reached a particular count, a determination is made as to whether a resource stall for strand 1 (S1) has occurred (314).

If a resource stall for strand 1 (S1) has occurred, strand 0 (S0) is continued (302). If a resource stall for strand 1 (S1) has not occurred, a determination is made as to whether strand 1 (S1) is alive (316). If strand 1 (S1) is not alive, strand 0 (S0) is continued (302). If strand 1 (S1) is alive, a switch to strand 1 (S1) is made.

An instruction(s) from strand 1 (S1) enters D1 (352). The instruction(s) may be part of a bundle of instructions. A determination is made as to whether strand 1 (S1) is in a parked or a wait state, or has caused an instruction refetch (354). An instruction refetch may occur if a branch misprediction or trap occurs.

If strand 1 (S1) is not in a parked or a wait state, or has not caused an instruction refetch, a determination is made as to whether a front end stall for strand 1 (S1) has occurred (356). If strand 1 (S1) is in a parked or a wait state, or has caused an instruction refetch, a determination is made as to whether strand 0 (S0) is alive (366), (for example, the computer system pipeline (200) shown in FIG. 2 determines the pipeline has instructions for strand 0).

If a front end stall for strand 1 (S1) has not occurred, a determination is made as to whether a resource stall for strand 1 (S1) has occurred (358). If a front end stall for strand 1 (S1) has occurred, strand 1 (S1) is continued (352). If strand 1 (S1) does not have a resource stall, a determination is made as to whether an instruction buffer for strand 1 (S1) is empty (360). If strand 1 (S1) does have a resource stall, a determination is made as to whether a resource stall for strand 0 (S0) has occurred (364).

If an instruction buffer for strand 1 (S1) is not empty, a determination is made as to whether a value of a counter (e.g., counter (230) shown in FIG. 2) has reached a particular count (362). If an instruction buffer for strand 1 (S1) is empty, a determination is made as to whether a resource stall for strand 0 (S0) has occurred (364). If a value of a counter has not reached a particular count, strand 1 (S1) is continued (352). If a value of a counter has reached a particular count, a determination is made as to whether a resource stall for strand 0 (S0) has occurred (364).

If a resource stall for strand 0 (S0) has occurred, strand 1 (S1) is continued (352). If a resource stall for strand 0 (S0) has not occurred, a determination is made as to whether strand 0 (S0) is alive (366). If strand 0 (S0) is not alive, strand 1 (S1) is continued (352). If strand 0 (S0) is alive, a switch to strand 0 (S0) is made.

One of ordinary skill in the art will understand that the strand starvation avoidance algorithm (300) may include additional or fewer decisions as to whether a switch to another strand should occur.

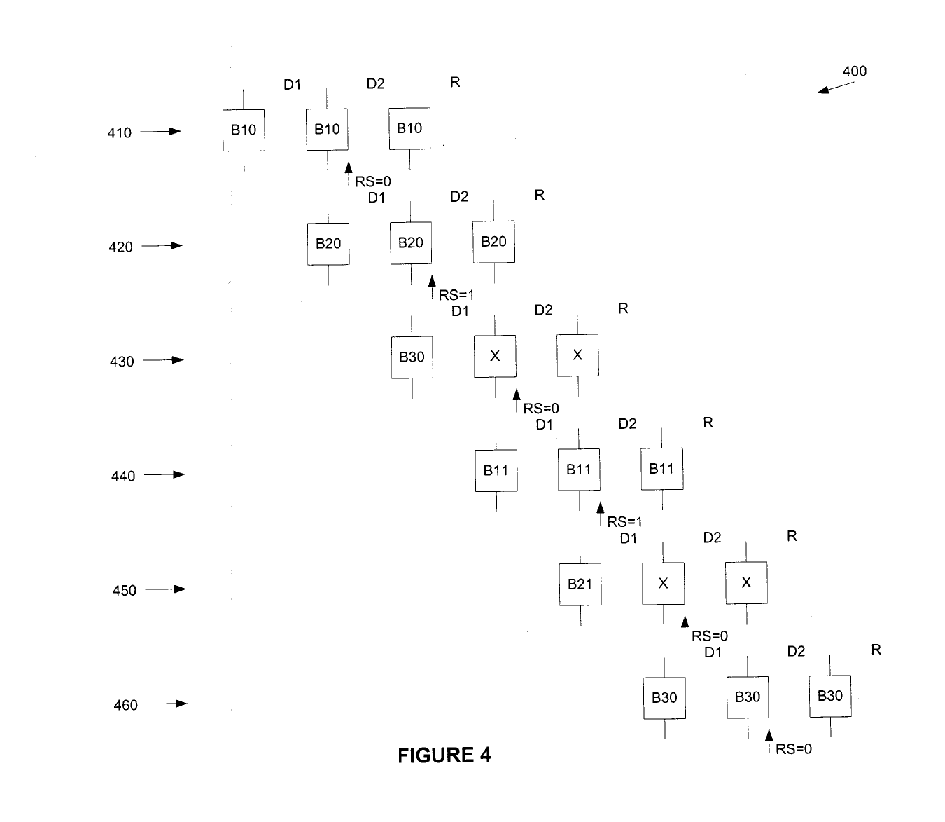

FIG. 4 shows an exemplary dual strand pipeline diagram (400) in accordance with an embodiment of the present invention. A pipeline diagram displays instructions at different stages in a pipeline at different times or clock cycles. Each horizontal line displays a single instruction or bundle of instructions as the single instruction or bundle of instructions progresses from one stage to another stage in the pipeline. For example in FIG. 4, a bundle of instructions for strand 0 (B10) enters (410) a first instruction decode stage (D1). At a next time increment, the bundle of instructions for strand 0 (B10) enters (410) a second instruction decode unit (D2) and a second bundle of instructions for strand 0 (B20) enters (420) the first instruction decode stage (D1). At a next time increment, the bundle of instructions for strand 0 (B 10) enters (410) a rename and issue unit (R), a second bundle of instructions for strand 0 (B20) enters (420) the second instruction decode unit (D2), and a third bundle of instructions for strand 0 (B30) enters (430) the first instruction decode stage (D1).

Two strands are represented in the pipeline diagram (400). Each bundle of instructions uses a first number to represent a bundle number. The bundles are numbered consecutively for each strand. A second number in the bundle of instructions represents one of two strands. For example, “B10” represents a first bundle of instructions for strand 0. For example, “B21” represents a second bundle of instructions for strand 1.

A resource stall (RS) is checked at a beginning of processing in the second decode stage (D2). If a resource stall occurs for a current strand (RS=1) and the other strand does not have a resource stall and is alive, the second decode stage (D2) switches strands. For example, the third bundle of instructions for strand 0 (B30) is applied (430) to the first decode stage (D1); however, a resource stall occurs (RS=1) at the beginning of processing in the second decode stage (D2) for the third bundle of instructions for strand 0 (B30). Accordingly, the third bundle of instructions for strand 0 (B30) does not enter (430) the second decode stage (D2). A bubble in the pipeline occurs (430) as indicated by “X.”

As a result of the resource stall (420), a first bundle of instructions for strand 1 (B11) enters (440) the first decode stage (D1). A resource stall occurred (RS=1) at the beginning of processing in the second decode stage (D2) for the second bundle of instructions for strand 1 (B21). Accordingly, the second bundle of instructions for strand 1 (B21) does not enter (450) the second decode stage (D2). A bubble in the pipeline occurs (450) as indicated by “X.” As a result of the resource stall (440), the third bundle of instructions for strand 0 (B30) is refetched (460) and enters the first decode stage (D1).

One of ordinary skill in the art will understand that a pipeline may have many stages that may include the stages shown in FIG. 4. A pipeline may have different stages than the stages shown in FIG. 4. A bundle may include one or more instructions. The instructions in the bundle may be processed out of order. Two or more strands may be supported by the pipeline. A resource stall may be indicated when a few resources are still available, but the resources may not be sufficient and/or advantageous to continue processing the current strand.

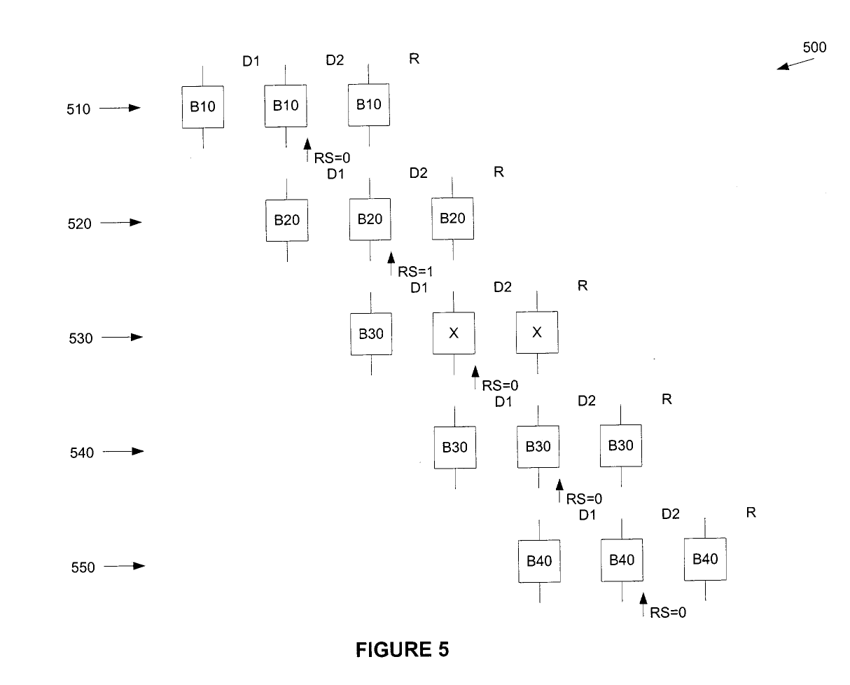

FIG. 5 shows an exemplary dual strand pipeline diagram (500) when strand 1 is parked, in a wait state, or has a resource stall in accordance with an embodiment of the present invention. A pipeline diagram displays instructions at different stages in a pipeline at different times or clock cycles. Each horizontal line displays a single instruction or bundle of instructions as the single instruction or bundle of instructions progresses from one stage to another stage in the pipeline. For example in FIG. 5, a bundle of instructions for strand 0 (B10) enters (510) a first instruction decode stage (D1). At a next time increment, the bundle of instructions for strand 0 (B10) enters (510) a second instruction decode unit (D2) and a second bundle of instructions for strand 0 (B20) enters (520) the first instruction decode stage (D1). At a next time increment, the bundle of instructions for strand 0 (B10) enters (510) a rename and issue unit (R), a second bundle of instructions for strand 0 (B20) enters (520) the second instruction decode unit (D2), and a third bundle of instructions for strand 0 (B30) enters (530) the first instruction decode stage (D1).

One strand is represented in the pipeline diagram (500). Each bundle of instructions uses a first number to represent a bundle number. The bundles are numbered consecutively for each strand. A second number in the bundle of instructions represents one of two strands. For example, “B10” represents a first bundle of instructions for strand 0.

A resource stall (RS) is checked at a beginning of processing in the second decode stage (D2). If a resource stall occurs for a current strand (RS=1) and the other strand does not have a resource stall and is alive, the second decode stage (D2) switches strands. The third bundle of instructions for strand 0 (B30) is applied (530) to the first decode stage (D1). A resource stall occurs (RS=1) at the beginning of processing in the second decode stage (D2) for the third bundle of instructions for strand 0 (B30). Accordingly, whether strand 1 is parked, in a wait state, or has a resource stall is determined. Strand 1 is in any one of the conditions that includes a parked state, wait state, or a resource stall. The third bundle of instructions for strand 0 (B30) does not enter (530) the second decode stage (D2). A bubble in the pipeline occurs (530) as indicated by “X.”

Because strand 1 is parked, in await state, or has a resource stall, the third bundle of instructions for strand 0 (B30) is held (530) at the beginning of the first decode stage (D1). Because resources are freed, the third bundle of instructions for strand 0 (B30) enters (540) the second instruction decode unit (D2). Because no resource stall occurs (RS=0) as the third bundle of instructions for strand 0 (B30) completes processing (540) in the second instruction decode unit (D2), the fourth bundle of instructions for strand 0 (B40) enters (550) the first decode stage (D1).

One of ordinary skill in the art will understand that a pipeline may have many stages that may include the stages shown in FIG. 5. A pipeline may have different stages than the stages shown in FIG. 5. A bundle may include one or more instructions. The instructions in the bundle may be processed out of order. Two or more strands may be supported by the pipeline. A resource stall may be indicated when a few resources are still available, but the resources may not be sufficient and/or advantageous to continue processing the current strand.

Advantages of the present invention may include one or more of the following. In one or more embodiments, a plurality of strands may be processed such that a processor may continue to perform useful operations even if one strand incurs a long latency event.

In one or more embodiments, one of a plurality of strands may be processed by a processor at any given time. To prevent a strand from consuming too many processing cycles, a strand starvation avoidance algorithm forces another strand to be processed.

In one or more embodiments, a decode unit may be arranged to switch strands to prevent strand starvation.

In one or more embodiments, a computer system pipeline may be arranged to operate on a plurality of strands such that resources are available to support switching between the plurality of strands.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for processing instructions, comprising:
fetching a first strand, wherein the first strand comprises instructions from a first process;
fetching a second strand, wherein the second strand comprises instructions from a second process; and
selectively switching from the first strand to the second strand dependent on whether a value of a counter has reached a particular count.

2. The method of claim 1, wherein the selectively switching is further dependent on whether the second strand is alive.

3. The method of claim 1, wherein the selectively switching further dependent on whether the second strand is not stalled.

4. The method of claim 1, wherein the selectively switching is further dependent on whether an instruction buffer for the first strand is empty.

5. The method of claim 1, wherein the selectively switching is further dependent on whether a resource stall for the first strand has occurred.

6. The method of claim 1, wherein the selectively switching is further dependent on whether a front end stall for the first strand has occurred.

7. The method of claim 1, wherein the selectively switching is further dependent on whether the first strand is parked.

8. The method of claim 1, wherein the selectively switching is further dependent on whether the first strand is in a wait state.

9. The method of claim 1, wherein the selectively switching is further dependent on whether an instruction refetch for the first strand has occurred.

10. An apparatus, comprising:
a commit unit arranged to identify instructions that have been committed for execution;
a counter arranged to count;
an instruction decode unit arranged to decode instructions from a first strand and a second strand, wherein the instruction decode unit selectively switches from the first strand to the second strand; and
a strand selection circuit arranged to indicate when to selectively switch from the first strand to the second strand dependent on:
whether the commit unit indicates that the second strand is alive, and
whether the counter has reached a particular value.

11. The apparatus of claim 10, wherein the strand selection circuit is further dependent on whether the second strand is not stalled.

12. The apparatus of claim 10, wherein the strand selection circuit is further dependent on whether a resource stall for the first strand has occurred.

13. The apparatus of claim 10, wherein the strand selection circuit is further dependent on whether a front end stall for the first strand has occurred.

14. The apparatus of claim 10, wherein the strand selection circuit is further dependent on whether the first strand is parked.

15. The apparatus of claim 10, wherein the strand selection circuit is further dependent on whether the first strand is in a wait state.

16. The apparatus of claim 10, further comprising:
an instruction fetch unit arranged to fetch instructions, wherein the strand selection circuit is further dependent on:
whether the instruction fetch unit for an instruction from the first strand is empty.

17. The apparatus of claim 16, wherein the strand selection circuit is further dependent on whether the instruction fetch unit refetches an instruction for the first strand.

18. A computer system, comprising:
a processor arranged to process a first strand and a second strand;
an instruction decode unit arranged to decode instructions for the processor, wherein the instruction decode unit is arranged to selectively switch from the first strand to the second strand; and
instructions adapted to cause the computer system to selectively switch from the first strand to the second strand dependent on:
whether the second strand is alive, and
whether a value of a counter has reached a particular count.

19. The computer system of claim 18, wherein the processor is arranged to simultaneously process multiple instructions.

20. The computer system of claim 18, wherein the processor is arranged to process instructions out of order.

21. The computer system of claim 18, wherein the instructions are further dependent on whether the second strand is not stalled.

22. The computer system of claim 18, wherein the instructions are further dependent on whether an instruction buffer for the first strand is empty.

23. The computer system of claim 18, wherein the instructions are further dependent on whether a front end stall for the first strand has occurred.

24. The computer system of claim 18, wherein the instructions are further dependent on whether the first strand is parked.

25. The computer system of claim 18, wherein the instructions are further dependent on whether the first strand is in a wait state.

26. The computer system of claim 18, wherein the instructions are further dependent on whether an instruction refetch for the first strand has occurred.

27. An apparatus, comprising:
means for fetching a first strand, wherein the first strand comprises instructions from a first process;
means for fetching a second strand, wherein the second strand comprises instructions from a second process;
means for determining whether the second strand is alive;
means for determining whether a value of a counter has reached a particular count; and
means for selectively switching from the first strand to the second strand dependent on the means for determining whether the second strand is alive and the means for determining whether the value of the counter has reached the particular count.
